(19) United States
(12) Patent Application Publication
(10) Pub. No.: US 2025/0285480 A1
(43) Pub. Date: Sep. 11, 2025

(54) SECURE DIGITAL DOOR STRIKE

(71) Applicant: Jason Dean Hart, Fremont, CA (US)

(72) Inventor: Jason Dean Hart, Fremont, CA (US)

(21) Appl. No.: 19/072,704

(22) Filed: Mar. 6, 2025

Related U.S. Application Data
(60) Provisional application No. 63/562,073, filed on Mar. 6, 2024.

(51) Int. Cl. G07C 9/00; E05B 47/00

(52) U.S. Cl. CPC G07C 9/00309; E05B 47/0046; G07C 9/00571; G07C 2009/00412

(57) ABSTRACT

A digital door strike device is an apparatus that remains secure until receiving credentialed digital messages to unlock and to return digital status messages which include door position, lock position, tamper indications, and air pressure. The apparatus includes a device installed in a door frame and a magnetic lock which secures the door. The apparatus receives power and communicates digitally over existing legacy power lines. The apparatus receives encrypted messages over the communication line. The magnetic lock is released when the apparatus receives an unlock message from a trusted remote device or door reader device.

The current application claims a priority to the U.S. provisional patent application Ser. No. 63/562,073 filed on Mar. 6, 2025.

### FIELD OF THE INVENTION

The present invention relates generally to door strikes and security. Particularly, the present invention is a digital door strike device that remains secure until receiving credentialed digital messages to unlock and to return digital status messages which include door position, lock position, tamper indications, and air pressure.

### BACKGROUND OF THE INVENTION

Today, most door strikes are analog. Determining if a lock should be open or closed is solely based upon the application of external power to the door strike. This outdated concept from the 1930's is inadequate in a modern data driven environment. The wide scale adoption of these legacy analog systems means an extensive rewiring effort is required to replace old devices. Replacement is costly and requires an installer to remove old wiring and replace with new data cabling.

Adding a microprocessor and communication system to the door strike housing enables encrypted communication between an external access control system and the door lock. This prevents hackers who can open the door by simply applying external power from a remote location to the old analog door strike.

One major challenge of the existing install based on door strikes is that generally only two wires are run from the access control system to the door strike. Some door strikes with input monitors may have three or four wires. As a result, adding a generic digital door strike generally requires long distance radio communications through metal or the rearrangement of the door strike cable through the roof and door frames. Neither is very practical just to improve the security of the door strike.

An objective of the present invention is to provide a door strike device with an integrated Safetrust intelligent module that enables a customer to easily upgrade existing door strikes without rewiring. The present invention further introduces door positioning and air pressure monitoring without the need to run new wires or to add new independent sensors. The door strike device is OSDP compliant for integration into legacy access control systems and is capable of independent operation with a Safetrust door reader device as a standalone access control solution with high levels of security.

### SUMMARY OF THE INVENTION

The present invention is a digital door strike device that remains secure until receiving credentialed digital messages to unlock and to return digital status messages which include door position, lock position, tamper indications, and air pressure.

The digital door strike device comprises a device installed in a door frame and a magnetic lock which secures the door. The digital door strike device receives power and communicates digitally over existing legacy power lines. The digital door strike device receives encrypted messages over the communication line. The magnetic lock is released when the digital door strike device receives an unlock message from a trusted remote device or door reader device.

In one embodiment of the present invention, the trusted communication may be received wirelessly over radio frequency such as Bluetooth Low Energy (BLE).

In another embodiment of the present invention, the trusted communication may be received wirelessly over radio frequency such as Long Range (LoRa) radio frequencies.

### BRIEF DESCRIPTION OF THE DRAWINGS

FIG. 1 is an illustration of the present invention.

FIG. 2 is an illustration of the present invention.

FIG. 3 is an illustration describing an enterprise use case of the present invention.

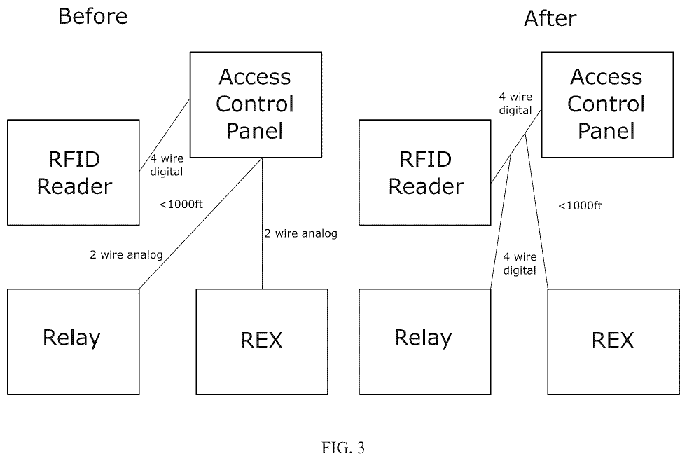

FIG. 4 is an illustration describing an SMB use case of the present invention.

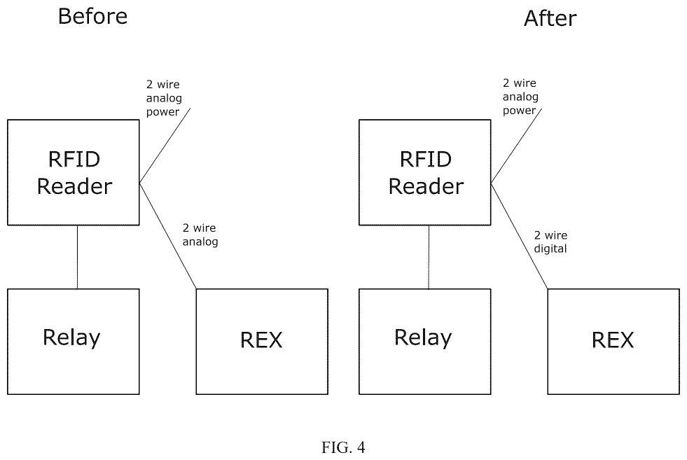

FIG. 5 is an illustration describing wireless ACS function to the present invention.

FIG. 6 is an illustration describing ACS function to the present invention over power lines.

FIG. 7 is an illustration describing the OSDP functionality of the present invention.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header. All illustrations of the drawings are for the purpose of describing selected versions of the present invention and are not intended to limit the scope of the present invention.

The present disclosure includes many aspects and features. Moreover, while many aspects and features relate to, and are described in the context of the disclosed use cases, embodiments of the present disclosure are not limited to use only in this context.

The present invention is a digital door strike device that remains secure until receiving credentialed digital messages to unlock and to return digital status messages which include door position, lock position, tamper indications, and air pressure.

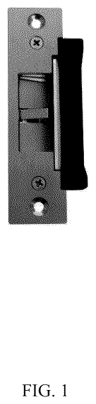

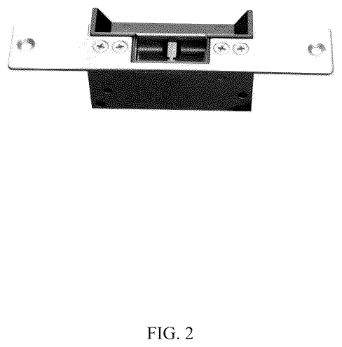

As shown and described in FIG. 1 and FIG. 2, the digital door strike device comprises a device installed in a door frame and a magnetic lock which secures the door. The digital door strike device receives power and communicates digitally over existing legacy power lines. The digital door strike device receives encrypted messages over the communication line. The magnetic lock is released when the digital door strike device receives an unlock message from a trusted remote device.

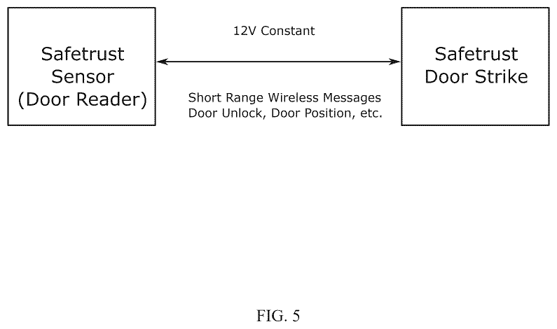

In one embodiment of the present invention, the trusted communication may be received wirelessly over radio frequency such as Bluetooth Low Energy (BLE). In this embodiment, wireless communication between the door reader and door strike is available through 2.4 GHz short range wireless messages. As shown and described in FIG. 5, the door strike device and a door reader device can communicate door unlock, door position, and other digital commands. In this embodiment, the door reader device is a digital device and is generally in close proximity to the door strike device. Power is supplied to the door strike device over standard power lines. The door strike device does not actuate the door unlocking mechanism until it receives a digital message from the door reader device to do so.

In another embodiment of the present invention, the trusted communication may be received wirelessly over radio frequency such as Long Range (LoRa) radio frequencies.

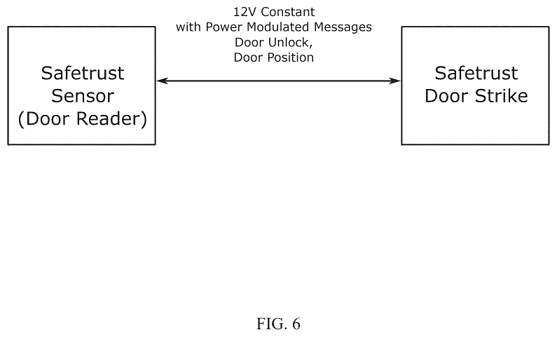

In another embodiment of the present invention, the door strike device can communicate with a door reader device over power lines with power modulated messages. As shown and described in FIG. 6, existing legacy power wires can be used for communication between the door strike device and a door reader device. This embodiment has the advantage of not requiring rewiring for installation. Most door strikes are wired with only two wires 12/24 VDC/Ground. Most intelligent door devices require power wiring separate from data wiring. As a result, it is often necessary for extensive rewiring to install a digital door strike device. In this embodiment, an access controller, either a panel or door reader device, can communicate with the door strike device over the existing two power wires by modulating the data signal onto the power lines. This communication permits bidirectional communication between the ACS and the door strike device without re-wiring.

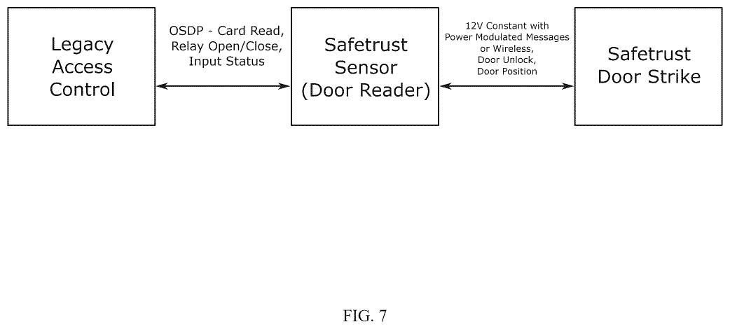

Adding a door strike device and a door reader device to a legacy access control panel becomes easier with a Safetrust sensor and the digital door strike device. As shown and described in FIG. 7, the Safetrust sensor is electrically powered and connected to the access control panel using the SIA OSDP protocol. The sensor exposes two OSDP devices, a door reader device and a door strike relay. The door strike device is not electrically connected to the ACS. Instead, the door strike device is connected directly to the Safetrust sensor. In this embodiment, the Safetrust sensor receives messages from the ACS panel instructing the Safetrust sensor to open the door strike device. The Safetrust sensor communicates digitally with the door strike device, then the door strike device releases the door. The door strike device also returns door position information which the Safetrust sensor returns to the ACS over the OSDP protocol. The protocol between a Safetrust sensor and the digital door strike can be digital over wireless, digital over-power line modulation, or RS-485, depending upon the installation.

In another embodiment of the present invention, the present invention may be incorporated as a smart relay as part of a gate. A gate keypad can be replaced with digital messages instead of analog signaling. In this embodiment, the present invention could utilize the original gate controller or function as an addon.

Although the invention has been explained in relation to its preferred embodiment, it is to be understood that many other possible modifications and variations can be made without departing from the spirit and scope of the invention.

What is claimed is:

1. A device comprising:
a door strike;
a magnetic lock;
wherein said device is installed in a door frame;
wherein said device receives power and communicates digitally over legacy power lines;
wherein said device can receive encrypted messages; and
wherein said magnetic lock is released when said device receives an unlock message from a trusted remote device.

2. The device of claim 1, wherein said unlock message can be received wirelessly over Bluetooth Low Energy (BLE) radio frequencies.

3. The device of claim 1, wherein said unlock message can be received wirelessly over Long Range (LoRa) radio frequencies.

4. The device of claim 1 further comprising:
legacy wiring; and
wherein said device can communicate with a door reader device over legacy wiring with power modulated messages.

5. The device of claim 1 further comprising:
a door reader;
wherein said door reader is electrically powered;
wherein said door reader is connected to an access control panel using SIA OSDP protocol;
wherein said door reader receives messages from an access control panel instructing said door reader to open said device;
wherein said door reader communicates digitally with said device; and
wherein said door reader sends an unlock message to said device.

6. The device of claim 1, wherein said device is incorporated as part of a gate, and wherein said device utilizes said gate's controller or function.

7. A device comprising:
a door strike;
a magnetic lock; and
legacy wiring;
wherein said device is installed in a door frame;
wherein said device receives power and communicates digitally over legacy power lines;
wherein said device can receives encrypted messages;
wherein said magnetic lock is released when said device receives an unlock message from a trusted remote device; and
wherein said device can communicate with a door reader device over legacy wiring with power modulated messages.

8. The device of claim 7, wherein said unlock message can be received wirelessly over Bluetooth Low Energy (BLE) radio frequencies.

9. The device of claim 7, wherein said unlock message can be received wirelessly over Long Range (LoRa) radio frequencies.

10. The device of claim 7 further comprising:
a door reader;
wherein said door reader is electrically powered;
wherein said door reader is connected to an access control panel using SIA OSDP protocol;
wherein said door reader receives messages from an access control panel instructing said door reader to open said device;
wherein said door reader communicates digitally with said device; and
wherein said door reader sends an unlock message to said device.

11. The device of claim 7, wherein said device is incorporated as part of a gate, and wherein said device utilizes said gate's controller or function.

12. A device comprising:
a door strike;
a magnetic lock;
legacy wiring; and
a door reader;
wherein said device is installed in a door frame;
wherein said device receives power and communicates digitally over legacy power lines;
wherein said device can receives encrypted messages;
wherein said magnetic lock is released when said device receives an unlock message from a trusted remote device;
wherein said device can communicate with a door reader device over legacy wiring with power modulated messages;
wherein said door reader is electrically powered;
wherein said door reader is connected to an access control panel using SIA OSDP protocol;
wherein said door reader receives messages from an access control panel instructing said door reader to open said device;
wherein said door reader communicates digitally with said device; and
wherein said door reader sends an unlock message to said device.

13. The device of claim 12, wherein said unlock message can be received wirelessly over Bluetooth Low Energy (BLE) radio frequencies.

14. The device of claim 12, wherein said unlock message can be received wirelessly over Long Range (LoRa) radio frequencies.

15. The device of claim 12, wherein said device is incorporated as part of a gate, and wherein said device utilizes said gate's controller or function.
